(19) United States
(12) Patent Application Publication
(10) Pub. No.: US 2024/0290124 A1
(43) Pub. Date: Aug. 29, 2024

(54) Systems, Methods and Computer Program Products for Determining Information from Image-Based Documents

(71) Applicant: Xero Limited, Te Aro (NZ)

(72) Inventors: Bryan Obright, Te Aro (NZ); Alan Oberg, Te Aro (NZ)

(21) Appl. No.: 18/588,671

(22) Filed: Feb. 27, 2024

(30) Foreign Application Priority Data
Feb. 28, 2023 (AU) 2023900525

(51) Int. Cl. G06V 30/413; G06V 30/412; G06V 30/414; G06V 30/416

(52) U.S. Cl. CPC G06V 30/413; G06V 30/412; G06V 30/414; G06V 30/416

(57) ABSTRACT

A method comprises: receiving extracted information comprising information extracted from a digital document, the digital document encoding a plurality of data items, each data item of the plurality of data items being associated with a data category of a plurality of data categories; selecting a first data category of the plurality of data categories; determining a plurality of potential configurations associated with the first data category of the plurality of data categories; determining based on the extracted information, whether a data item associated with the first data category is identifiable at the first potential configuration; and in response to a data item associated with the first data category not being positioned at a first potential configuration, determining, based on the extracted information, whether a data item associated with the first data category is identifiable at a second potential configuration.

### TECHNICAL FIELD

Embodiments generally relate to systems, methods and computer-readable media for categorising information from a digital document. In particular, embodiments relate to identification and categorisation of information encoded in a digital representation of a financial document.

### BACKGROUND

Manually reviewing physical or digital documents to identify and extract data of particular data categories can be a time-intensive, arduous and error-prone process. For example, a financial document may need to be visually inspected by a human to extract and categorise specific data items from the document such as dates, financial account numbers and financial account balances. After the visual identification of the data items in the document, the categorised data items may need to be manually entered into a computer system to provide the computer with machine-encoded information. Such data entry processes are often prone to human error. Significant time and resources may be expended to ensure that complete and accurate data entry has been performed.

It is desired to address or ameliorate one or more shortcomings or disadvantages associated with such prior art, or to at least provide a useful alternative hereto.

Throughout this specification the word ‘comprise’, or variations such as ‘comprises’ or ‘comprising’, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY

Systems and methods provided provide for the categorisation of information from a visual representation of alpha-numeric data.

According to one aspect, there is provided a method comprising receiving extracted information comprising information extracted from a digital document, the digital document encoding a plurality of data items, each data item of the plurality of data items being associated with a data category of a plurality of data categories, and each data item of the plurality of data items being associated with a configuration in the digital document. The method further comprises: selecting a first data category of the plurality of data categories; determining a plurality of potential configurations associated with the first data category of the plurality of data categories, the plurality of potential configurations comprising at least a first potential configuration and a second potential configuration; and determining, based on the extracted information, whether a data item associated with the first data category is identifiable at the first potential configuration. The method further comprises, in response to a data item associated with the first data category not being positioned at the first potential configuration, determining, based on the extracted information, whether a data item associated with the first data category is identifiable at the second potential configuration.

In some embodiments, the method further comprises, in response to a data item associated with the first data category being positioned at the second potential configuration, categorising the data item with the first data category.

In some embodiments, the extracted information comprises one or more of: text information; key-value pairs; tabulated data; formatting information; and structural information.

In some embodiments, the method further comprises parsing the digital document to extract the extracted information. In some embodiments, the method further comprises receiving the digital document.

In some embodiments, the digital document defines a two-dimensional region, and wherein the potential configuration comprises a location in the two-dimensional region.

In some embodiments, the extracted information comprises structural information. In some embodiments, the structural information comprises one or more key-value pairs, and wherein the potential configuration comprises a value of a key-value pair having a defined key. In some embodiments, the structure information comprises tabulated data items,

In some embodiments, the potential configuration comprises a table entry in the tabulated data positionally associated with a column heading. In some embodiments, the potential configuration comprises a table entry in the tabulated data positionally associated with a row heading.

In some embodiments, the first data category is associated with a keyword, and wherein the potential configuration comprises a data item positionally associated to the keyword

In some embodiments, the first potential configuration defines one or more of: a spatial position within the digital document; a region within the digital document; a positional association with an associated data item; a key of a key-value pair; a table column heading; a table row heading; a positional association with a structural element of the digital document; a structural association with an associated data item; a formatting style; a pattern of the data item; and a regular expression.

In some embodiments, the plurality of potential configurations comprises an ordered list of potential configurations.

In some embodiments, the method further comprises determining the ordered list of potential configurations based on data extracted from a plurality of input documents.

In some embodiments, the method further comprises adjusting an order of the ordered list of potential configurations based on data extracted from a plurality of input documents.

In some embodiments, the method further comprises selecting a second data category of the plurality of data categories; determining a plurality of potential configurations associated with the second data category of the plurality of data categories, the plurality of potential configurations comprising at least a first potential configuration for the second data category and a second potential configuration for the second data category; and determining whether a data item associated with the second data category is positioned at the first potential configuration for the second data category.

In some embodiments, the digital document comprises a financial record

According to another aspect, there is provided a machine-readable storage medium storing instructions which, when executed by one or more processors, individually or in combination, cause the one or more processors to perform the method of any one of the claims.

According to another aspect, there is provided a system comprising one or more processors, and memory comprising computer executable instructions, which when executed by the one or more processors, individually or in combination, cause the system to perform the method of any one of the claims.

### BRIEF DESCRIPTION OF THE DRAWINGS

The invention will now be described with reference to the accompanying drawings, in which:

FIG. 1 is a block diagram of a system for determining a data category for a data item displayed in a display object on a user interface of a client device, according to an embodiment;

FIG. 1 is a block diagram of system for identifying and categorising data represented in a digital document, according to an embodiment;

FIG. 2 illustrates a process flow diagram of a method for determining data items from an input document, according to an embodiment;

FIG. 3 illustrates a portion of an example input document, according to an embodiment;

FIG. 4 illustrates a subset of output data, as output by the extraction module in response to performing the extraction process on an input document, according to an embodiment;

FIGS. 5, 6 and 7 each depict a separate example bank statement, or an extract thereof, from three different banks, according to embodiments;

FIGS. 8A to 8E each illustrate an extract of a separate example bank statement summary tables, according to embodiments;

FIG. 9 illustrates, the potential configurations for the ‘opening balance’ data category, according to an embodiment;

FIG. 10 illustrates, the potential configurations for the ‘opening date’ data category, according to an embodiment; and

FIG. 11 illustrates a process, as performed by the data identification module, to categorise data items of an input document, according to an embodiment.

Various ones of the appended drawings merely illustrate example embodiments of the present disclosure and cannot be considered as limiting its scope.

### DESCRIPTION OF THE EMBODIMENTS

There are many forms in which data comprising text, numbers and symbols may be displayed in a document. The position and form of data in the document, relative to other data and visual aspects of the document, can attribute meaning to the data. This meaning can be interpreted by the reader of the document, such that the reader can identify data associated with various data categories. For example, the position of a number in a table under the heading ‘Account balance’ may convey to the reader that the number represents an account balance, and the reader may therefore categorise that number as an account balance. Similarly, the position of text to the right hand side of the phrase ‘Account name:’ may convey to the reader that the text represents the account name, and the reader can therefore categorise that text as an account name.

It is often desirable to digitise and automate the process of identifying and extracting meaning from a digital document. In particular, it is often desirable to digitise and automate the process of identifying, extracting and categorising data from digital financial documents for the purposes of accounting, bookkeeping, and other management purposes.

Financial documents can encode (e.g. display, represent) financial data in a variety of different forms, including variations in the layout of information in the document, variations in the form in which the data is represented, variations in the sets of data included in the document, variations in the formatting and structural styles of the alphanumeric data, variations in the languages used, as well are other variations to the content or form of the data.

For example, data may be tabulated, text can be provided in multiple rows, the document may include headers, and the document may include non-data elements such as borders or white-space, which convey meaning to the reader.

Such variations in form and content add complexity to the design of automated processes for extracting and categorising data that is represented within a financial document.

It is common for financial institutions to issue a variety of different types of financial documents (e.g. bank statement, credit card statement, investment portfolio summary, account transaction summary), each financial document comprising different sets of data, and presenting data in accordance with a different template. Furthermore, it is common for each financial institution to present data in a template that is unique to that financial institution. Thus, the financial document issued by one financial institution differs visually, and in terms of content, from the financial document issued by another financial institution. Furthermore, a financial institution may use a variety of different templates for the same type of financial document.

It is also common for a financial institution to revise or adjust a document template from time to time, to modify the appearance or content of the document, or to add additional information such as marketing content or important messages.

One approach to addressing this complexity is to obtain knowledge of a plurality of existing templates in which a financial document can represent information, and to develop a tailored process for each of those templates. In relation to financial documents, this approach may manifest in the development of a data extraction method for each financial institution of a plurality of financial institution.

Developing a plurality of extraction process, each tailored for a particular document template, can be costly and time consuming. The development of tailored extraction processes is based on knowledge of the various document templates, and therefore it is often necessary to obtain prior knowledge of the various document templates in order to prepare the tailored extraction processes. Furthermore, there may be considerable maintenance of the set of tailored extraction processes as financial institutions issue documents in new or revised templates.

Additionally, an extraction process that is tailored for a particular document template may not be sufficiently robust to successfully extract the desired data if the document deviates from the expected document template.

Accordingly, there is a desire to determine an improved method of extracting data from a multitude of varied, and frequently changing document templates.

Embodiments provided herein may reduce the need to develop data extraction methods that are tailored for individual bank statement formats. Embodiments provided herein may allow for the processing of input documents produced in accordance with a template that has not previously been processed by the system. Embodiments provided herein define a set of potential locations, formats or positions for each category of data item to be extracted from an input document.

### System Block Diagram

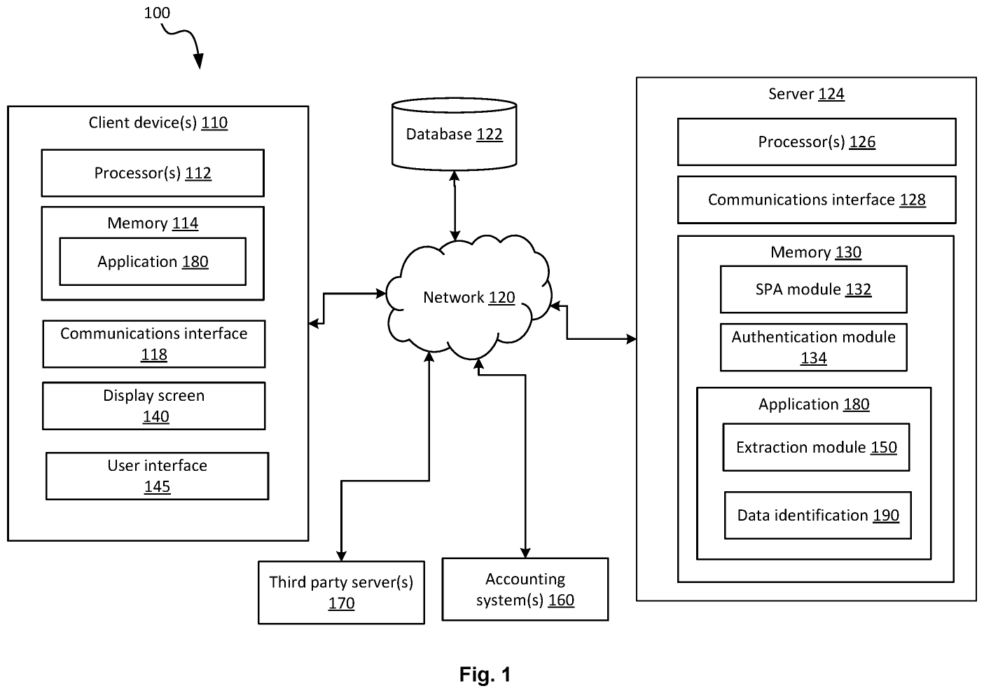

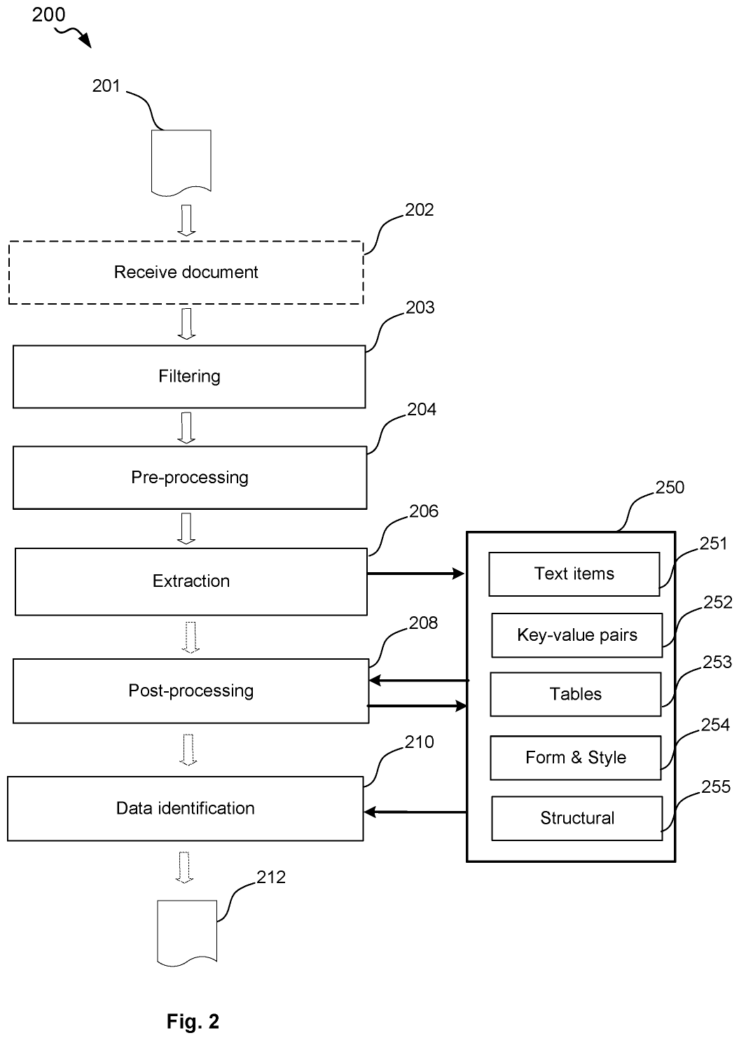

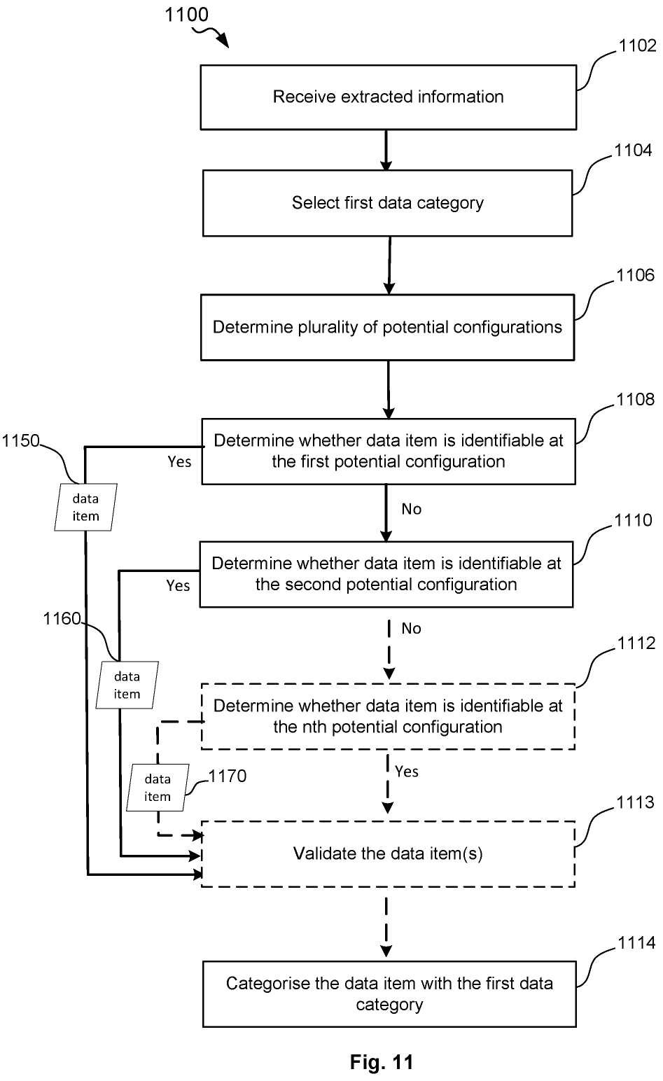

FIG. 1 is a block diagram of system 100 for identifying and categorising data represented in a digital document, according to an embodiment. The system 100 of FIG. 1 provides means for implementing the method illustrated in process flow diagram FIG. 11.

As illustrated, the system 100 may comprise one or more client device(s) 110, external database 122, data presentation server 124, one or more accounting system(s) 160 and/or one or more third party server(s) 170 in communication over a network 120.

Client device 110 may comprise a mobile or handheld computing device such as a smartphone or tablet, a laptop, or a PC, and may, in some embodiments, comprise multiple computing devices. The client device 110 may comprise one or more processor(s) 112, memory 114 and/or communications interface 118. The processor(s) 112 may comprise one or more microprocessors, central processing units (CPUs), application specific instruction set processors (ASIPs), application specific integrated circuits (ASICs) or other processors capable of reading and executing instruction code. The processor(s) 112, individually or in combination, may be configured to receive stored instructions (i.e. program code) from memory 114, which when executed by the processor(s) 112 may cause the client device 110 to function according to the described embodiments. Client device 110 comprises one or more display screens 140, the or each of the one or more display screens 140 being configured to display the GUI in implementing a method, such as that illustrated in FIG. 11.

Functionality determining arrangement and content of the GUI is provided by the processor hardware 112, and the memory hardware 114, which may be cooperating with data presentation server 124 and/or accounting system 160.

The functionality of the system 100 may be defined by application 180. Application 180 may comprise extraction module 150. Alternatively, extraction module 150 may be an application separate from application 180. Application 180 may comprise data identification module 190. Alternatively, data identification module 190 may be an application separate from application 180. Application 180 may be executed, in part or in full, on client device 110. Application 180 may be executed, in part or in full, on server 124. Machine-readable code (e.g.

software) defining application 180 may be stored, in part or in full, on client device 110. Machine-readable code (e.g. software) defining application 180 may be stored, in part or in full, on server 124. The application 180 may receive inputs (e.g. input documents) from database 122, or from other sources internal to the server 124, internal to the client 110, or accessible over the network 120. The application 180 may store the output products in database 122, in memory 130, memory 114, and/or transmit the output products over network 122.

The application 180 may be a single page application served by the data presentation server 124 to the client device 110 over the network 120 and displaying content from (for example, invoices or bills), or based on data obtained from the accounting system 160.

The memory 114 may comprise application 180 which comprises computer executable code, which when executed by the one or more processors 112 individually or in combination, is configured to allow client device 110 to facilitate the intuitive viewing and navigation of data displayed on a screen 140 of the client device 110. The communications interface 118 facilitates communications with components of the communications interface 118 across the network 120, such as: database 122, data presentation server 124, accounting system(s) 160 and/or third party server(s) 170. The communications interface 118 may comprise a combination of network interface hardware and network interface software suitable for establishing, maintaining and facilitating communication over a relevant communication channel.

The network 120 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 120 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The database 122 may form part of or be local to the system 100, or may be remote from and accessible to the system 100, for example, via the communications network 120. The database 122 may be configured to store data associated with the system 100. The database 122 may be a centralised database. The database 122 may be a mutable data structure. The database 122 may be a shared data structure. The database 122 may be a data structure supported by database systems such as one or more of PostgreSQL, MongoDB, and/or ElasticSearch. The database 122 may be configured to store a current state of information or current values associated with various attributes (e.g., “current knowledge”).

The data presentation server 124 may be configured to serve single page applications to the client device 110. Single page applications may comprise GUIs. The GUIs of single page applications provide a mechanism for a user of a client device to view, navigate, manipulate, and/or interact with data stored by the accounting system 160. The data stored by the accounting system 160 may comprise, inter alia, representations of transaction data, such as digital or softcopy versions of account statements or transaction statements. The data stored by the accounting system 160 may comprise representations of financial documents, such as bank account statements, invoices, bills, receipts, issued to or by the user (or a business or other legal entity on behalf of which the accounting system 160 is providing an online bookkeeping service).

In some embodiments, the data presentation server 124 may comprise one or more processors 126 and memory 130 storing instructions (e.g. program code) which when executed by the processor(s) 126 causes the system 100 to function according to the described methods. The processor(s) 126 may comprise one or more microprocessors, central processing units (CPUs), application specific instruction set processors (ASIPs), application specific integrated circuits (ASICs) or other processors capable of reading and executing instruction code.

In some embodiments, the data presentation server 124 may operate in conjunction with or support one or more external devices, such as the client device 110, the database 122, the accounting system(s) 160 and/or the third party server(s) 170, to manage the provision of an intuitive GUI for stored data.

The memory 130 may comprise one or more volatile or non-volatile memory types. For example, memory 130 may comprise one or more of random access memory (RAM), read-only memory (ROM), electrically erasable programmable read-only memory (EEPROM) or flash memory. Memory 130 is configured to store program code accessible by the processor(s) 126. The program code comprises executable program code modules. In other words, memory 130 is configured to store executable code modules configured to be executable by the processor(s) 126. The executable code modules, when executed by the processor(s) 126, individually or in combination, cause the system 100 to perform the functionality according to the described embodiments, as described in more detail below. Memory 130 may comprise a single page applications (SPA) module 132, which stores and serves single page applications (SPAs) to user devices such as client devices. Memory 130 may comprise an authentication module 134, which may, for example, check credentials to enable users to login to the service.

### Process Overview

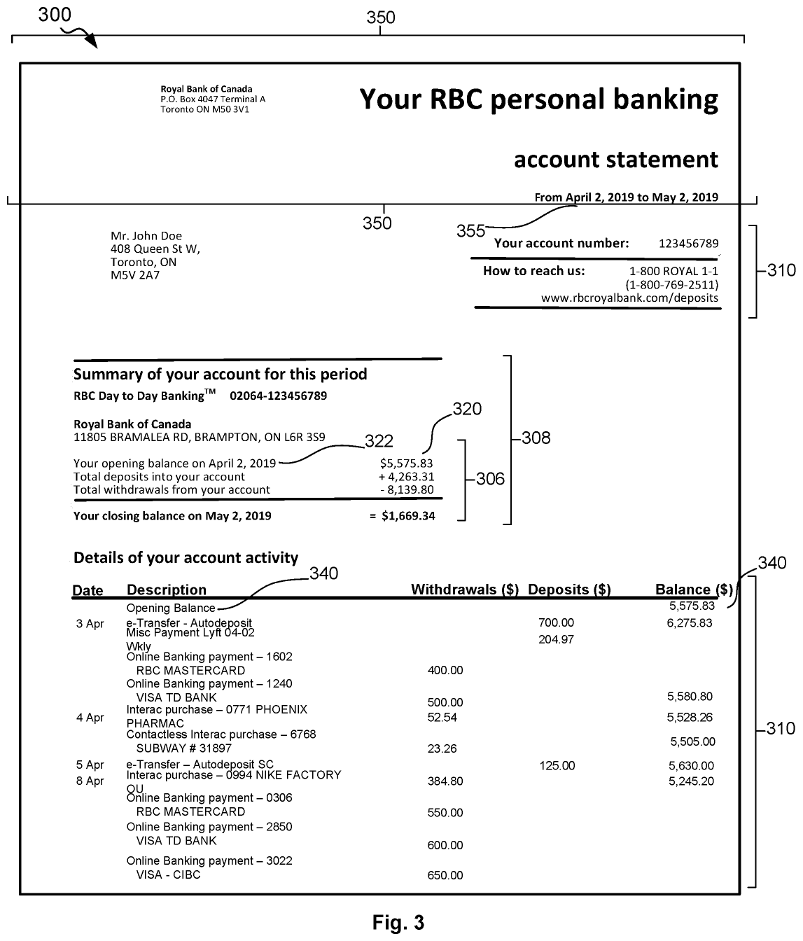

FIG. 2 illustrates a process flow diagram, including process inputs and outputs, of a method 200 for determining data items from an input document 201, according to an embodiment. The method 200 may be performed by application 180.

In step 202, the application 180 receives the input document 201. The input document 201 may be received from, for example, the client device 110, the database 122, the accounting system(s) 160, or via network 122.

In some embodiments, input document 201 comprises a digital file. The digital file may be in the format of a Adobe Portable Document Format (PDF), a Joint Photographic Experts Group (JPEG) format, a Portable Network Graphics (PNG) format, a Tag Image File Format (TIFF), or another digital format.

In some embodiments, the input document 201 comprises a financial document. In some embodiments, the input document 201 comprises a bank statement.

### Document Filtering

In step 203, the application 180 may be configured to perform a filtering step to filter out input documents that may be unsuitable to undergo the data extraction process 206. Input documents 201 that are identified as unsuitable during step 203 are filtered out of the process 200 and an error message may be provided by the application 180 to a user.

The application 180 may filter out an input document if the file size of the document is too small, compared to a pre-configured minimum file size, or if the file is empty. In some embodiments, the extraction module 150, which performs the data extraction process 206, has a maximum file size limit. Accordingly files that have a size above the maximum file size limit may be filtered out by the filtering process 202.

In some embodiments, the extraction module 150 is configured to support documents of a specific set of file formats. For example, the extraction module 150 may be configured to support only documents in the format of a Abode Portable Document Format (PDF), a Joint Photographic Experts Group (JPEG) format, a Portable Network Graphics (PNG) format, or a Tag

Image File Format (TIFF). If a document 201 is of a file format other than the file formats supported by the extraction module 150, the filtering process 202 may filter out the document 201.

### Pre-Processing

In the pre-processing step 204, the application 180 processes the document 201 so that the document is suitable for the extraction module 150 to perform the extraction process 206.

In some embodiments, the extra application 180 may be configured to convert an input document of an unsupported file format to a document of a file format supported by the extraction module 150.

In some embodiments, in the pre-processing step 204, the application 180 removes some combination of tilt, skew and page curl from the document 201. In some embodiments, in the pre-processing step 204, the application 180 attempts to compensate for quality issues (such as insufficient pixel density, excessive noise, and/or insufficient contrast) with the document 201. In some embodiments, in the pre-processing step 204, the application 180 attempts to determine whether the document 201 has been altered. Alteration may be an indication of fraudulence. The application may identify alterations by identifying localised changes in quality, such as pixelated text with a body of clear text).

In some embodiments, in the pre-processing step 204, the application 180 corrects alignment issues such that the data content of the document 201 is orientated close to a 90 degree axis. In some embodiments, in the pre-processing step 204, the application 180, removes watermark or stamp from document 201.

### Data Extraction

At step 206, the extraction module 150 parses the input document 201 to determine and extract output data 250. The extraction module 150 may identify a plurality of data fields represented in the input document, extract the contents of each data field independently, and compose the extracted data into a normalised representation 250 of the input document 201.

The extraction module 150 may comprise one or more machine learning (ML) models to locate and extract data items (including alphanumeric data and symbols) from the document. The ML model may be an AI model that incorporates deep learning based computation structures, including artificial neural networks (ANNs).

In one embodiment, the data extraction process 206 is performed by a text extraction service. The text extraction service may comprise an optical character recognition (OCR) service. In one embodiment, the text extraction service comprises Amazon Textract. In one embodiment, the text extraction service comprises a combination of third party software services or libraries, and custom data extraction services or libraries.

In one embodiment, the filtering 203, pre-processing 204 and extraction 206 steps are not specific to financial documents, or indeed to bank statements.

### Example Bank Statement

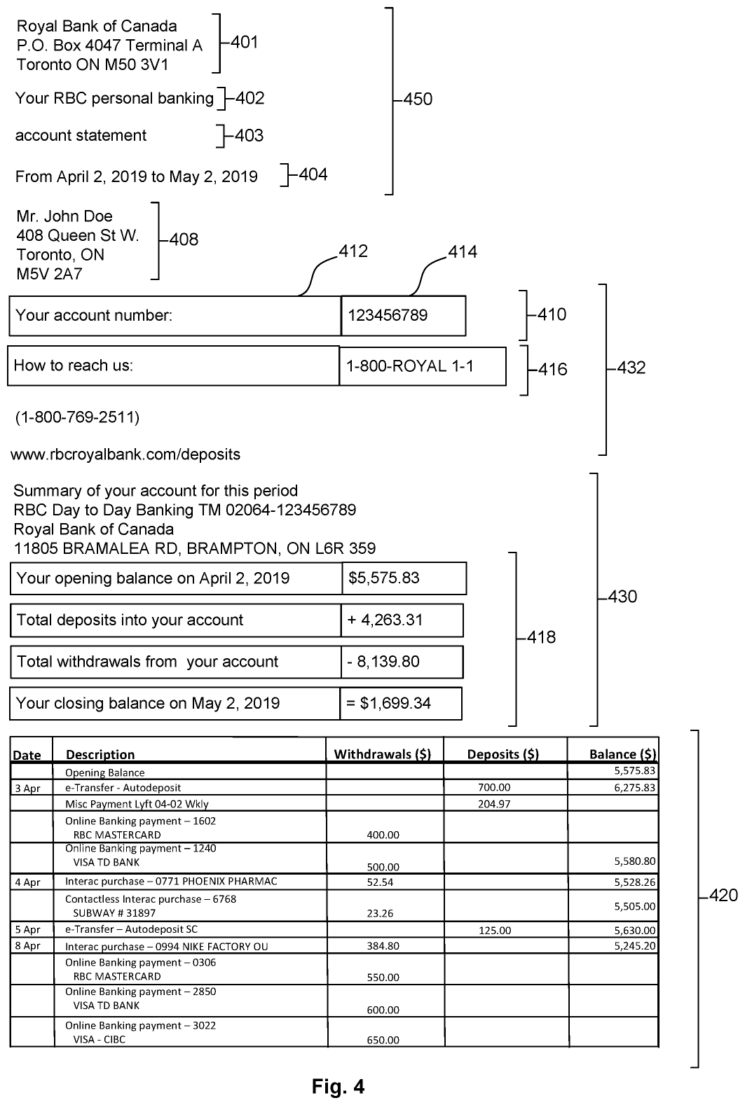

FIG. 3 illustrates a portion of an example input document 300, according to an embodiment. More particularly, input document 300 comprises a visual representation of a page of a bank statement for an example bank account held by the Royal Bank of Canada. In embodiments, the input document 300 may comprise a scanned or photographed copy of a page of a paper hardcopy of an account statement. The input document 201 may comprise a machine-encoded information, non-machine-encoded information, or a combination thereof. In some embodiments, the input document does not comprise machine-encoded text. Accordingly, optical character recognition (OCR) module (also referred to as a character recognition module), or similar, may apply a character recognition algorithm to the display object to determine machine-readable characters represented in the input document. The machine-readable characters may comprise alpha-numerical characters, including symbols.

Input document 300 visually represents an address and name of the account holder. Furthermore, the input document visually represents a date period for which the account statement applies. Input document also visually represents a plurality of data items which are arranged in a tabular form, i.e. the data items are arranged in a plurality of columns and rows. In particular, the rows of the tabulated data items are associated with individual financial transactions that have occurred on the bank account associated with the account number. Furthermore, the columns of the tabulated data items, on the input document, are associated with various attributes of the financial transactions; namely, the posted date of the transaction, a description of the transaction, the amount of funds withdrawn (if any), the amount of funds deposited (if any) and the balance of the account in response to the occurrence of the financial transaction.

In embodiments, information represented by input documents may comprise additional attributes, fewer attributes or a different set of attributes. For example, an input document may comprise an invoice and include only data items belonging to an amount category and a description category.

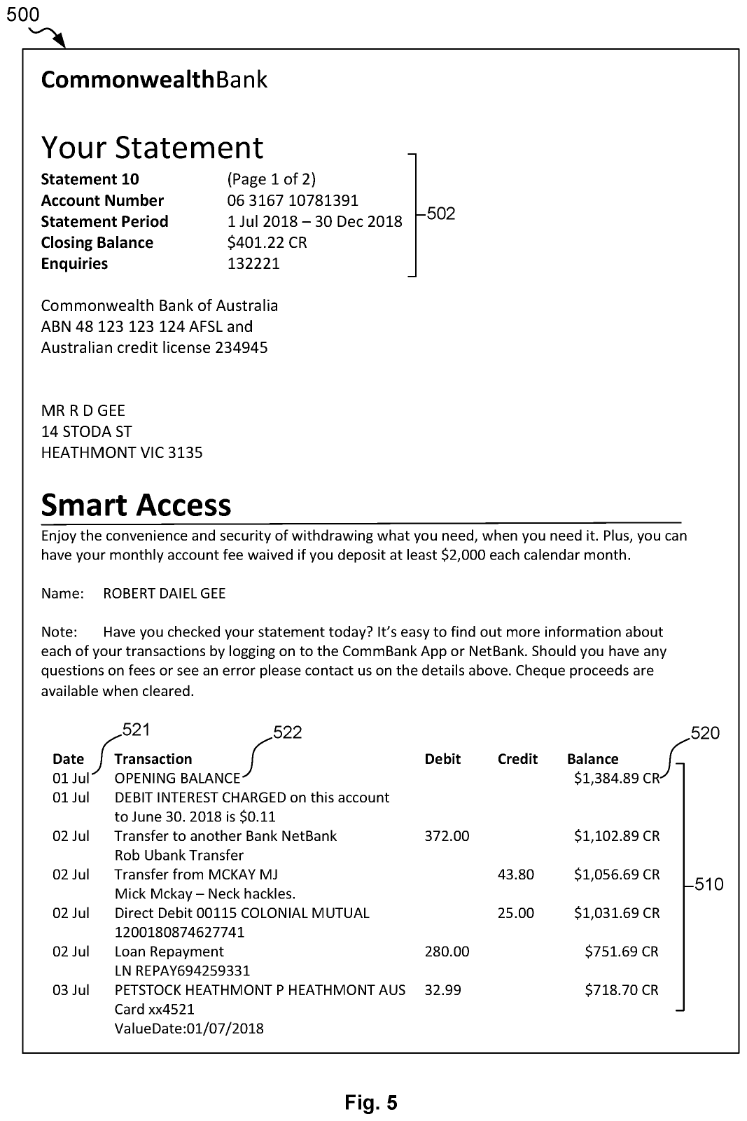

In one embodiment, in accordance with step 206 of process 200, the extraction module 150 processes input document 300 to output data as shown in FIG. 4.

### Extraction Outputs

FIG. 4 illustrates a subset of output data 250, as output by the extraction module 150 in response to performing the extraction process on input document 300, according to an embodiment.

In one embodiment, the extraction module 150 is configured to identify alphanumeric text in document 300 and to output a plurality of data items representing the alphanumeric text. Alphanumeric text may comprise symbols, such as, but not limited to, +, −, $, and/or %. A data item may comprise one or more numbers, letters, symbols or any combination thereof. The extraction module 150 may be configured to identify information displayed in multiple languages and/or various character sets.

In some embodiments, the extraction module 150 is configured to identify and extract text information from the input document 201. The text information may comprise alphanumeric text 251. The extraction module may group the alphanumeric text into sets, based on the position of the alphanumeric text in the document 300, the format of the text in document 300, or structural elements of document 300. For example, text 401 has been grouped by the extraction module 150 because that text was closely located together in document 300.

### Key-Value Pairs

In some embodiments, the extraction module 150 is configured to identify and extract key-value pairs 252 from the document 201. A key-value pair comprises text indicating a key, and corresponding text which indicates a value for the key. In one example, a key-value pair for an account number comprises a key=‘account’ and a value=‘123456789’.

In FIG. 4, key-value pairs are indicated by adjacent paired boxes. For example, key-value pair 410 comprises a key 412 and a value 414 associated with that key.

In the example of FIG. 4, the extraction module 150 identifies text 306 as a set of four key-value pairs 418. In other embodiments, the extraction module 150 may be configured to identify text 306 as a two-by-four table of data.

### Table Data

In some embodiments, the extraction module 150 is configured to identify tables in input document 201, and extract information regarding cells, merged cells, and column headers of the tables, and extract the contents of the table cells. The extraction module 150 may output, as 253, the tabulated alphanumeric data along with information defining the tabulated structure of the data. For example, the extraction module may output the tabulated data in the form of comma-separated variables.

In the example of FIG. 4, the extraction module 150 identifies data 310 as a table, and outputs tabulated data items 420.

In some embodiments, the extraction module 150 is configured to determine whether a table is a vertical table, in which the table headings are positioned in a first row above the table entries associated with the heading, or whether the table is a horizontal table, in which the table headings are positioned in a first column to the left of the table entries associated with the heading.

### Formatting Data

In some embodiments, the extraction module 150 is configured to identify and output formatting data 254 during the extraction process. Formatting data may comprise an indication of the size, font, colour, format, whether alphanumeric text is italicised, bolded, or underlined, or other visual aspects of the text data identified in the input document (e.g. 300).

### Structural Information

In some embodiments, the extraction module 150 is configured to identify and output structural information 255 of document 300 during the extraction process 206. Structural elements may comprise border lines, boxes, placement of non-alphanumeric features, such as images, or other visual features.

In one embodiment, the extraction module 150 identifies that alphanumeric data 308 is grouped together in a region of the document 300, and surrounded by white space. Accordingly, the extraction module 150 identifies that alphanumeric data 308 is positionally associated. The extraction module 150 outputs structural information (not shown) that indicates that output data 430 is positionally associated. Similarly, the extraction module may identify that data 310 is positionally associated, and output structural information (not shown) that indicates that output data 432 is positionally associated.

In some embodiments, the extraction module 150 is configured to identify key blocks of information represented by document 300. In one embodiment, the extraction module is configured to identify a summary block of information. In one embodiment, the extraction module is configured to identify the summary block by identifying a block of positionally associated alphanumeric data which includes the word ‘summary’ in the first line. In the examples of FIG. 3, document 300 comprises a summary block 308. The extraction module may be configured to output structural information (not shown) to indicate that output data 430 comprises a summary block.

### Confidence Values

In some embodiments, the extraction module 150 is configured to provide a confidence value associated with the data items of the output data 250, output by the extraction module 150.

### Post-Processing

In some embodiments, the output data 250 determined by the extraction module 150 in step 206 may be further processed via a post-processing step 208, performed by a post-processing module. In some embodiments, the post-processing step is configured based on the type of input document 201 to be processed, or the purpose of application 180. For example, in some embodiments, the post-processing step is configured to apply post-processing to output data 250, wherein the post-processing is tailored for the processing of financial documents. In some embodiments, the post-processing step 208 alters, adjusts or amends the output data 250 that was output by the extraction step 206.

In some embodiments, the post-processing module is configured to, in post-processing step 208, determine spatial regions within the document 201, and determine what data is positioned within each of the spatial regions. In some embodiments, the structural information 255 comprises an indication of the inclusion of data items within spatial regions within the document 201.

Example bank statement 300 of FIG. 3 comprises a header region, as indicated by the pair of brackets 350. Accordingly, the structural information 255 may indicate that document 300 comprises a header region 350 and the header region comprises output data 450.

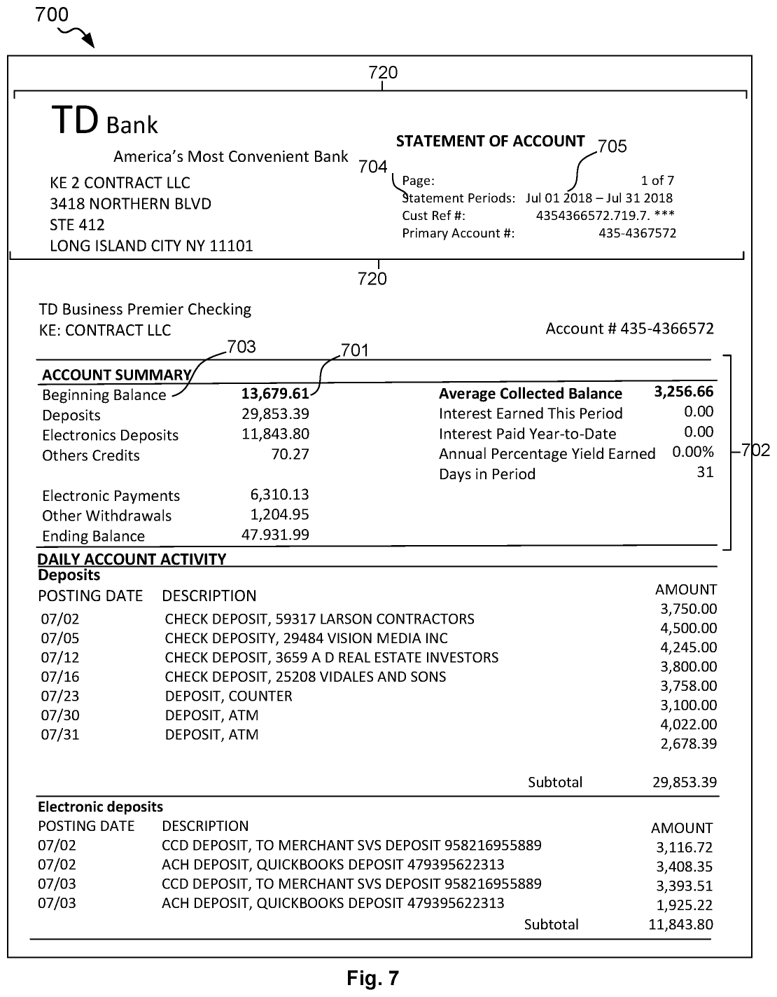

Similarly, post-processing module may be configured to identify the presence of a document footer in the input document 201. In some embodiments, the post-processing module may be configured to identify the presence of a summary table (as depicted in FIG. 8A to 8E) in an input document 201, and the data item contents of the summary table.

In some embodiments, the post-processing module is configured to, in post-processing step 208, determine the presence and location of landmarks within the document 201. Landmarks may comprise borders, logos, images, backgrounds, or other visual features.

In some embodiments, the post-processing module is configured to determine positional information based on the structural information 255. The positional information may identify the bounds of the data as per the visual form of the input document. The positional information may comprise page numbers, bounding coordinates of the input document, bounding regions defined in accordance with a height and a width, and/or bounding regions defined in accordance with a list of point coordinates. Positional information may comprise an indication of structural hierarchy of the input document, including headings and heading levels.

### Financial Data Categories

Numerous financial institutions issue bank statements and other financial documents. Financial documents comprise important information that defines the status of a financial account on a particular date or over a particular period, and/or the activity occurring on the financial account over a particular period of time.

For accounting and bookingkeeping purposes, it is desirable to extract, and digitally store information from the financial document. Information contained in a financial document may be categorised into various data categories, reflecting the nature of the information with respect to the meaning and purpose of the financial document.

For example, in some embodiments, it is desirable to extract, from a bank statement, information corresponding to data categories including: the name of the bank; the branch identifier of the bank; the account number; and/or the name of the account holder. Furthermore, it is often desirable to extract, from a bank statement, information corresponding to data categories including: an opening date for the bank statement; a closing or end date for the bank statement; an opening balance; a closing balance; and/or a list of transactions that have occurred on the bank account during the period between the opening and closing dates.

It will be understood that the data categories described herein are not intended to be an exhaustive or a limiting list. For other types of documents, and for other applications it will be understood that it may be desirable to identify and extract information corresponding to different or additional data categories.

### Example Debit Bank Statements

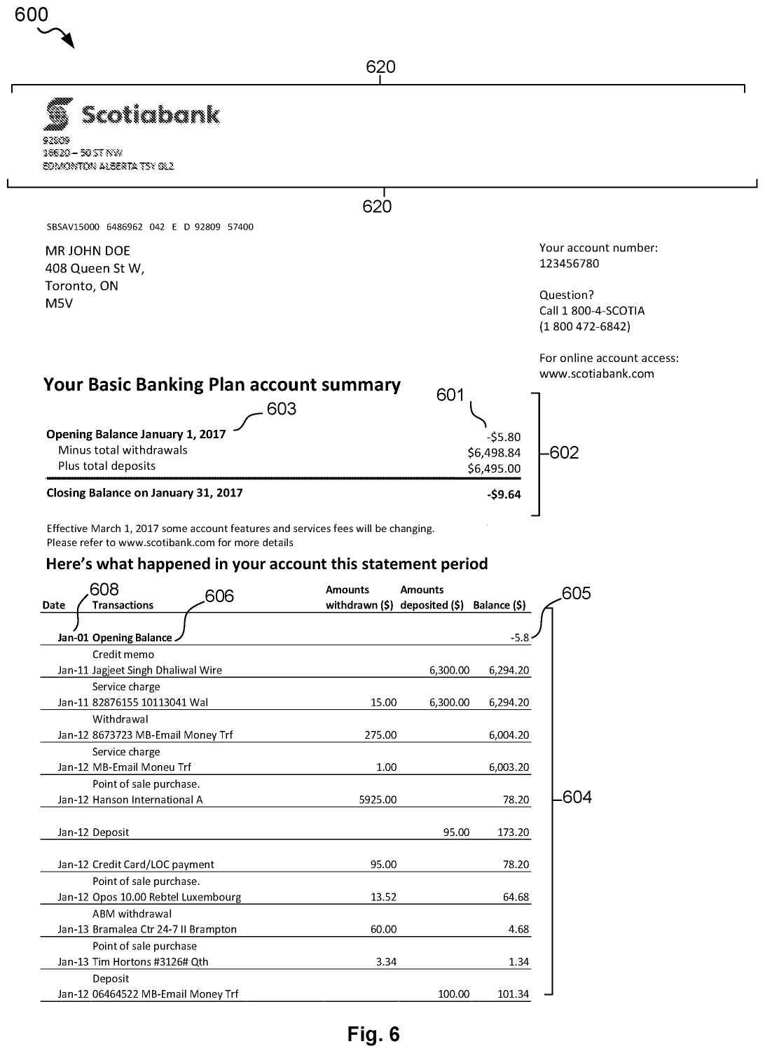

FIGS. 5, 6 and 7 each depict a separate example bank statement, or an extract thereof, from three different banks, according to embodiments. It will be appreciated that there are many aspects of variation across the format, layout and contents of the various bank statements depicted in FIGS. 5, 6 and 7. For example, the opening balance is provided on bank statements in a variety of positions, and in a variety of forms, depending upon the layout of the bank statement as selected by the issuer of the bank statement.

In bank statement 300, the opening balance is provided in the summary information 308, in position 320, next to text 322. Furthermore, the opening balance is also provided in position 340, in association with text 342, as the first row of table 310.

In bank statement 500, the opening balance is provided in position 520, in the first row of table 510, in association with the phrase ‘OPENING BALANCE’ 522. Notably, in bank statement 500, the opening balance is not provided in the first table of information 502.

In bank statement 600, the opening balance is provided in position 601, in the summary table 602, in association with the phrase ‘Opening Balance Jan. 1, 2017’ 603. The opening balance is also provided in position 605, in the first row of table 604, in association with the entry ‘Opening Balance’ 606, and the phrase ‘Jan-1’ 608.

In bank statement 700, the opening balance is provided in position 701, in the summary table 702, in association with the phrase ‘Beginning Balance’ 703.

### Data identification

In process 210, the application 180 performs a data identification process on output data 250 comprising identifying, from extracted data 250, data items for each data category of a set of data categories.

As noted above, one method of extracting, from a bank statement, data values for a set of data categories is to develop an extraction template that hard-codes the knowledge regarding the particular templates used by each bank of a set of banks, for the bank statements.

Considering the example bank statement illustrated in FIG. 3, an extraction template may be configured to identify a set of key-value pairs in a first summary table (e.g. 308) and extract the value 320 of the first key-value pair 322-320 as the opening balance. Accordingly, applying this template would correctly extract the value $5,575.83 as the opening balance for input document 300. However, if this template was applied to the example bank statement 500 of FIG. 5, the value ‘(Page 1 of 2)’ may be erroneously extracted as the opening balance. Accordingly, a different or tailored template would be more suited to the extraction of data items from bank statement 500.

### Configurations

A data item in an input document may be identified by a configuration associated with that data item. A configuration of a data item may define the spatial position of the data item within the digital document 201 (e.g. in the header region of the input document); a positional association between the data item and an associated data item (e.g. to the right of the phrase ‘Current balance’); a positional association between the data item and a structural element of the digital document (e.g. under the bank logo); a structural association between the data item and an associated data item (e.g. in a table entry below the column heading ‘Deposits’); a format of the data item (e.g. text above 20 pt in size'); a pattern of the data item (e.g. a number of the pattern XXXX.XX); a regular expression (e.g. contains the word ‘opening’, or starts with ‘224’, or is a value >5000, or does NOT include the symbol ‘-’); or any combination thereof.

### Potential Configurations

In one embodiment, the data identification module 190 determines a set of potential configurations associated with a data category. In some embodiments, potential configurations provide a means for the data identification module 190 to identify and extract a data item from the input document, via the output data 250, without having prior knowledge of the source of the input document or the template used to format the data in the input document. Accordingly, in some embodiment, the data identification module can use potential configurations to extract data from a bank statement, without the need to use a tailored extraction template.

A potential configuration provides the data identification module with an indication of where to find a data item, associated with the data category, in the extracted data 250 of an input document.

A potential configuration may define the spatial position of a data item within the digital document 201 (e.g. in the header region of the input document); a positional association between a data item and an associated data item (e.g. to the right of the phrase ‘Current balance’);

a positional association between a data item and a structural element of the digital document (e.g. under the bank logo); a structural association between a data item and an associated data item (e.g.

in a table entry below the column heading ‘Deposits’); a format of a data item (e.g. text above 20 pt in size'); a pattern of a data item (e.g. a number of the pattern XXXX.XX); a regular expression related to a data item (e.g. contains the word ‘opening’, or starts with ‘224’, or is a value >5000, or does NOT include the symbol ‘-’); or any combination thereof.

Potential configuration may define positional associations with text that is case-sensitive or not case sensitive.

### Example 1—Opening Balance

FIGS. 8A to 8E each illustrate an extract of a separate example bank statement summary tables, according to embodiments. In particular, FIGS. 8A to 8E illustrate tables that the application 180 has identified as summary tables. In one embodiment, application 180 may identify, in post-processing step 208, that the tables are summary tables.

FIG. 11 illustrates a process 1100, as performed by the data identification module 190, to categorise data items of an input document, according to an embodiment.

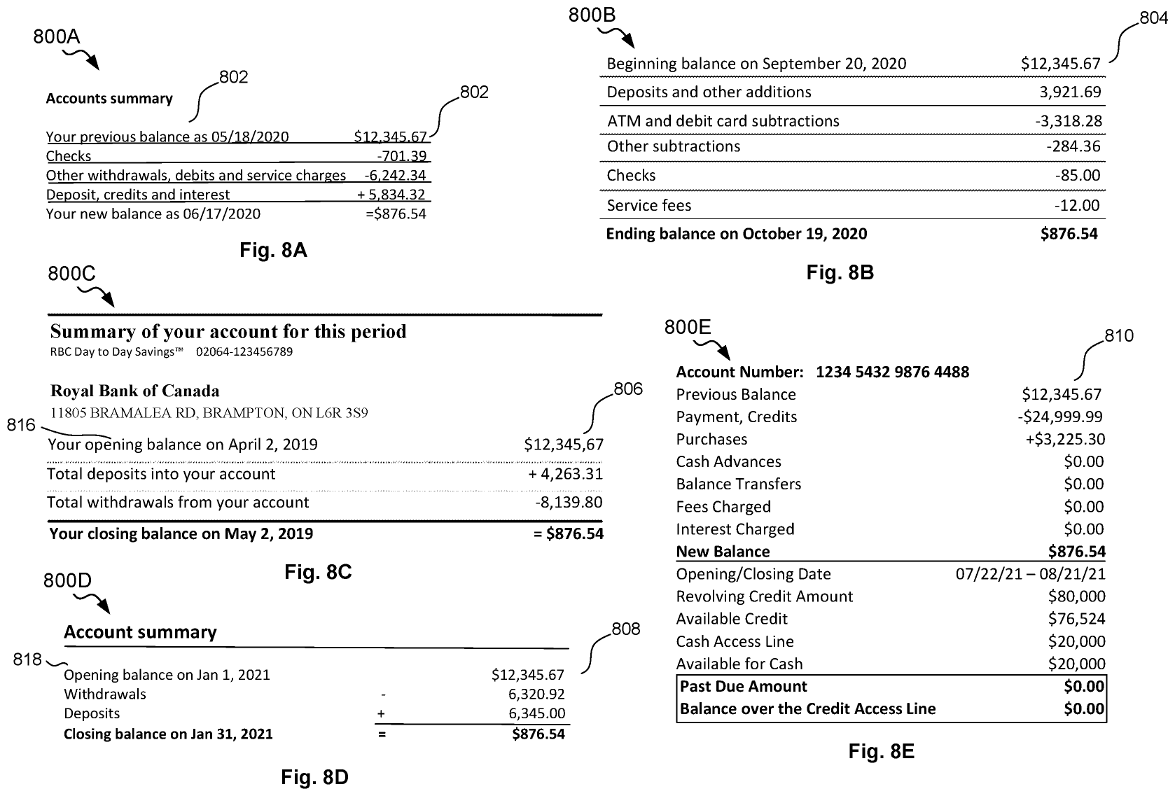

FIG. 9 illustrates, the potential configurations 900 for the ‘opening balance’ data category, according to an embodiment. In one embodiment, the potential configurations 900 are ordered, from a first potential configuration 902 to a sixth potential configuration 907.

In one example, with reference to FIGS. 8A to 8E and FIG. 9, the data identification module 190 is configured to perform process 1100 of FIG. 11 to attempt to identify a data item of the data category ‘opening balance’, within the summary table of documents 800A, 800B, 800C, 800D and 800E.

In step 1102, the data identification module 190 is configured to receive information 250 extracted from an input document. In step 1104, the data identification module 190 selects a first data category, being ‘opening balance’ in this example.

In step 1106 determines a plurality of potential configurations 900 associated with the first data category. The plurality of potential configurations may be retrieved by the data identification module 190 from memory 114 or 130, or from database 122.

In step 1108, the data identification module 190 is configured to attempt to identify a data item associated with the ‘opening balance’ data category by looking for the data item in accordance with a first potential configuration 902. In some embodiments, the data identification module attempts to identify a data item has a format consistent with the data category selected in step 1104. For example, if the data category comprises a date, the data identification module attempts to identify a date value by looking for the date in accordance with a first potential configuration 902.

In some embodiment, the system may be configured to determine a data item representing a date in accordance with methods disclosed in co-pending Australian provisional patent application Ser. No. 2023900523, filed on 28 Feb. 2023, and entitled “Methods, systems and computer program products for determining date information”, the entire content of which is incorporated herein by reference.

In accordance with the example first potential configurations 902, the data identification module 190 is configured to attempt to identify a data item associated with the ‘opening balance’ data category by looking for a numerical data item that is positionally associated with the keyword ‘opening balance’ within the block of output data 250 that has been identified by the post-processing process 208 as the summary table. In accordance with the potential configuration 902, the keyword ‘opening balance’ comprises a defined key.

The numerical data item may be positionally associated with the key words ‘opening balance’ by being a value of a key-value pair in which the key comprises the key words ‘opening balance’. The numerically data item may be positionally associated with the key words ‘opening balance’ by being a table entry in the row which includes a heading comprising the key words ‘opening balance’. The numerically data item may be positionally associated with the key words ‘opening balance’ by being a table entry in the column which includes a heading comprising the key words ‘opening balance’. The numerically data item may be positionally associated with the key words ‘opening balance’ by being a numerical value in the same group of text as the key words ‘opening balance.

With reference to example summary table 800C, the data item 806 associated with the data category ‘opening balance’ is positioned in the summary table 800C, positionally associated with the key words ‘opening balance’ 816. Accordingly, in response to the data identification module 190 determining a data item 806 positioned in the summary table 800C, and positionally associated with the key words ‘opening balance, the data identification module 190 identifies the data item 806 as an identified data item 1150 and, in step 1114, the data identification module 190 categorises the data item 1150, having value $12,345.67, to the data category ‘opening balance.

Similarly, in the summary table 800D, the data item 808 associated with the data category ‘opening balance’ is positioned in the summary table 800D, positionally associated with the key words ‘opening balance’ 818. Accordingly, in response to the data identification module 190 determining that the data item 808 is positioned in accordance with the first potential configuration 902, the data identification module 190 identifies the data item 808 as identified data item 1150 and, in step 1114, the data identification module 190 categorises the data item 1150, having value $12,345.67, with the data category ‘opening balance.

In contrast to the summary tables 800C and 800D, in summary table 800A, the data item 802 associated with the data category ‘opening balance’ is positioned in the summary table 800A, but it is not positionally associated with the key words ‘opening balance’. Accordingly, the data identification module 190 fails to identify the data item 802 at the first potential configuration 902.

In step 1110, in response to the data identification module 190 determining that a data item is not being positioned at the first configuration, the data identification module 190 is configured to attempt to determine a data item positioned at the second potential configuration 903. In particular, in response to the data identification module 190 determining a data item 802 positioned in the summary table 800A, and positionally associated with the key words ‘previous balance, the data identification module 190 identifies the data item 802 as the identified data item 1160, and, in step 1114, the data identification module categories the data item 1160, having value $12,345.67, with the data category ‘opening balance.

Similarly, in the summary table 800E, the data item 810 associated with the data category ‘opening balance’ is positioned in the summary table 800E, positionally associated with the key words ‘previous balance’. Accordingly, in response to the data identification module 190 determining that the data item 810 is positioned in accordance with the second potential configuration 903, the data identification module 190, in step 1114, categorises the data item 808, having value $12,345.67, with the data category ‘opening balance.

With regard to summary table 800B, the data item 810 associated with the data category ‘opening balance’ is positioned in the summary table 800E, positionally associated with the key words ‘beginning balance’. Accordingly, in response to the data identification module 190 determining that: the data item 804 is not positioned in accordance with the first potential configuration 902; the data item 804 is not positioned in accordance with the second potential configuration 903; the data item 804 is not positioned in accordance with the third potential configuration 904; and the data item 804 is not positioned in accordance with the fourth potential configuration 905, the data identification module 190 determines whether the data item 804 is positioned in accordance with the fifth potential configuration 906. In response to determining that the data item 804 is positioned in accordance with the fifth potential configure 906, the data identification module categorises the data item 804, having value $12,345.67, with the data category ‘opening balance’.

### Example 2—Opening Date

Bank statements are often associated with a reporting period defined by a specific opening date and a specific closing (or ending) date. The reporting period defines the period of time to which the information conveyed by the bank statement relates.

In some embodiments, the data identification module 190 is configured to determine a data item associated with the ‘opening date’ data category.

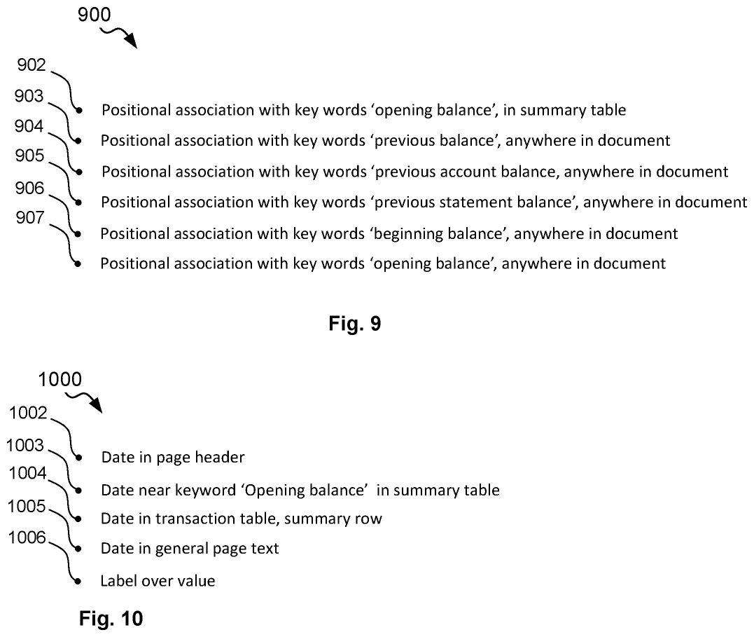

FIG. 10 illustrates the potential configurations 1000 for the ‘opening date’ data category, according to an embodiment. In one embodiment, the potential configurations 1000 are ordered, from a first potential configuration 1002 to a fifth potential configuration 1007.

In one embodiment, the data identification module 190 is configured to attempt to identify a data item associated with the ‘opening date’ data category by looking for the data item in accordance with a first potential configuration 1002.

In accordance with the example first potential configurations 1002, the data identification module 190 is configured to attempt to identify a data item associated with the ‘opening date’ data category by looking for a date field within a region that has been identified by the post-processing process 208 as the page header.

With reference to example bank statement 300, the data item 355 associated with the data category ‘opening date’ is positioned in the page header region 350. Accordingly, in response to the data identification module 190 determining a data item 355 positioned in the header region 350, the data identification module 190 categorises the data item 355, having value ‘Apr. 2, 2019’, with the data category ‘opening date’.

Similarly, with reference to example bank statement 700, the data item 705 associated with the data category ‘opening date’ is positioned in the page header region 720. Accordingly, in response to the data identification module 190 determining a data item 705 positioned in the header region 720, the data identification module 190 categorises the data item 705, having value ‘Jul. 1, 2018’, with the data category ‘opening date’.

With reference to example bank statement 600, the data item 603 associated with the data category ‘opening date’ is positioned in the summary table 602, rather than in the page header 620. Accordingly, in response to the data identification module 190 determining a date data item is not positioned in the header region 620, in accordance with the first potential configuration 1002, the data identification module 190 determines whether the opening date data item is positioned near the key word ‘opening balance’ in the summary table 602, in accordance with the second potential configuration 1003. In response to the data identification module 190 determining a data item 603 positioned in the summary table 602 near the key word ‘opening balance’, the data identification module 190 categorises the data item 603, having value ‘Jan. 1, 2017’, with the data category ‘opening date’.

With reference to example bank statement 500, the data item 521 associated with the data category ‘opening date’ is positioned in the summary line of the transaction table 510. Accordingly, the data identification module 190 does not identify a data item association with an opening date in accordance with the first potential configuration 1002, or the second potential configuration 1003. However, in response to the data identification module 190 determining a data item 521 positioned in the summary row of the transaction table 510, the data identification module 190 categorises the data item 521, having value ‘1 July’, with the data category ‘opening date’.

### Validating the data item

In some embodiments, the data identification module 190 is configured to perform a validation step 1113 on the identified data item, before the data identification module 190 categorises the identified data item in step 1114.

In some embodiments, the validation step 1113 comprises determining, based on the data item itself, whether the identified data item makes sense as a data item of the data category.

For example, if the data category pertains to a date, the validation step 1113 may comprise determining whether the identified data item (e.g. data items 1150, 1160, 1170) satisfy predetermined requirements regarding the format of the data item or the information represented by the data item.

For example, for data categories pertaining to dates, the data identification module 190 may apply methods as disclosed in co-pending Australian provisional patent application 2023900523, filed on 28 Feb. 2023, and entitled “Methods, systems and computer program products for determining date information”, the entire content of which is incorporated herein by reference, to determine whether the identified data item comprises a date.

Similarly, for data categories pertaining to currency amounts, the data identification module 190 may determine whether the identified data item represents a numerical currency value. This may include determining the presence of currency symbols in positional association with the data item in the input document.

In some embodiments, the validation step 1113 comprises determining, based on the data item and other data extracted from the input document, whether the identified data item makes sense as a data item of the data category. For example, for the data category ‘closing date’, the validation step 1113 may comprise confirming that the data item identified as a closing date represents a data occurring after the opening date already extracted from the input document.

The data identification module 190 may be configured to determine, in the validation step 1113, a confidence level associated with the identified data item (e.g. data items 1150, 1160 and 1170). The confidence level may indicate how well the identified data item satisfies the requirements.

### Multiple Potential Configurations

FIG. 10 depicts a process in which the data identification module 190 proceeds through the plurality of potential configurations one-by-one, until a data item for the data category is identified in the extracted output data 250. In this process, once the data identification module 190 identifies a suitable data item in accordance with a potential configuration, the data identification module does not proceed to identify any further data items in accordance with any other potential configurations. However, in some embodiments, the data identification module is configured to attempt to identify a plurality of data items from the extracted output data 250, based on a plurality of potential configurations. In some embodiments, the data identification unit identifies a plurality of identified data items (e.g. data items 1150, 1160 and 1170) and, in validation step 1113, the data identification module is configured to determine, which of the plurality of data items should be categorised with the data category selected in step 1104.

In some embodiments, a data item corresponding to a data category may be located in a plurality of locations within an input document. For example, the opening balance may be included in a summary table, and may also be included in the first row of the transaction table.

Accordingly, a plurality of identified data items (e.g. data items 1150, 1160 and 1170) may be suitable for categorising with the data category selected in step 1104.

In some embodiments, the data identification module 190, in the validating step 1113, selects one of the plurality of identified data items (e.g. data items 1150, 1160 and 1170) for categorising with the data category selected in step 1104. The data identification module may select one of the identified data items based on a confidence level; an order of the potential configurations; the results of performing the validation step 1113 on the data item; or other considerations.

### Ordering Potential configurations

In one embodiment, the plurality of potential configurations comprises an ordered list of potential configurations. The ordered list of potential configurations may be derived from an analysis of a large number of input documents. The first potential configuration may comprise the most frequently occurring configuration. The order of the potential configurations may be revised, adjusted or reordered based on an analysis of frequency of occurrence.

The data identification module 190 may skip one or more potential configurations in the ordered list of potential configurations for a second data category, in light of identifying an actual configuration for a first data category.

### Display and Annotate

In one embodiment, the application 180 is configured to display the input document as a display object on a display screen 140 of the client device 110. In one embodiment, the application 180 is configured to annotate the display object with a visual indication of the tabular form that has been determined by the application. The visual indication of the tabular form may be referred to as a tabular form indication. The tabular form indication may comprise lines, shading, spatially associated text (e.g. column headings) or any combination thereof.

In one embodiment, a user may indicate, via use of the user interface 145, that the tabular form indicated by the application is not correct or should be adjusted. The user may indicate adjustments to the tabular form indicated by the application. In response to user input, the application may adjust the determined tabular form of the data items.

### Categorisation Indication

In one embodiment, the application 180 is configured to visually indicate the categorisation of data items that have been categorised by the application data identification module 190. In one embodiment, a categorisation indication comprises a rectangle which encompasses a data item in the display object. In one embodiment, the categorisation indication comprises: highlighting the data item; annotating the display object to change the color of the text of the data item; applying a background effect to the data item; underlining the data item; labelling the data item; applying any effect which visually distinguishes the categorised data item from uncategorised data items, or data items of a different category; or any combination of these aspects.

In one embodiment, the application 180 applies a first categorisation indication for a first data category, and a second categorisation indication for a second data category. The first data categorisation is visually distinct from the second data categorisation in terms of colour, shape, visual effect, pattern, associated alphanumeric annotations, or any combination thereof.

### Validating Inferred Categorisations

In one embodiment, the application 180 provides for the user to trouble shoot, validate or remove errors from the categorisation of the data items by the data identification module 190. In one embodiment, the application annotates the display object with one or more categorisation indications which represent categorisations of the data items in the display object. The application 180 provides for the user, via the user interface 145, to provide user input that contradict, adjust or confirm the data categorisations made by the data identification module 190.

Examples described herein and illustrated in the figures comprise data items which are arranged such that the data items that are associated with a single transaction are arranged in a horizontal row of a tabular form. It is to be understood that in embodiments, data items that form a set of associated data items (such as data items that describe a financial transaction, or an invoice item) may be arrange in either rows or columns, and that a single display object may comprise sets of associated data items arranged in rows and sets of associated data items arranged in columns. The methods and systems described herein may be applied in any of these circumstances.

It will be appreciated by persons skilled in the art that numerous variations and/or modifications may be made to the above-described embodiments, without departing from the broad general scope of the present disclosure. Furthermore, it will be appreciated by persons skilled in the art that embodiments disclosed herein can be combined with one or more other embodiment disclosed herein, without departing from the broad general scope of the present disclosure. The present embodiments are, therefore, to be considered in all respects as illustrative and not restrictive.

References herein to software or executable instructions are to be understood as referring to executable instructions stored in volatile or non-volatile memory. The memory can include any data storage device that can store data which can thereafter be read by a processor. Examples of memory include read-only memory (ROM), random-access memory (RAM), magnetic tape, optical data storage device, flash storage devices, or any other suitable storage devices.

What is claimed is:

1. A method comprising:
receiving extracted information comprising information extracted from a digital document, the digital document encoding a plurality of data items, each data item of the plurality of data items being associated with a data category of a plurality of data categories, and each data item of the plurality of data items being associated with a configuration in the digital document;
selecting a first data category of the plurality of data categories;
determining a plurality of potential configurations associated with the first data category of the plurality of data categories, the plurality of potential configurations comprising at least a first potential configuration and a second potential configuration;
determining based on the extracted information, whether a data item associated with the first data category is identifiable at the first potential configuration; and
in response to a data item associated with the first data category not being positioned at the first potential configuration, determining, based on the extracted information, whether a data item associated with the first data category is identifiable at the second potential configuration.

2. The method of claim 1, further comprising, in response to a data item associated with the first data category being positioned at the second potential configuration, categorising the data item with the first data category.

3. The method of claim 1, wherein the extracted information comprises one or more of:
text information;
key-value pairs;
tabulated data;
formatting information; and
structural information.

4. The method of claim 1, further comprising parsing the digital document to extract the extracted information.

5. The method of claim 4, further comprising receiving the digital document.

6. The method of claim 1, wherein the digital document defines a two-dimensional region, and wherein the plurality of potential configurations comprises a location in the two-dimensional region.

7. The method of claim 1, wherein the extracted information comprises structural information.

8. The method of claim 7, wherein the structural information comprises one or more key-value pairs, and wherein the plurality of potential configurations comprises a value of a key-value pair having a defined key.

9. The method of claim 7, wherein the structure information comprises tabulated data items.

10. The method of claim 9, wherein the plurality of potential configurations comprises a table entry in the tabulated data items positionally associated with a column heading.

11. The method of claim 9, wherein the plurality of potential configurations comprises a table entry in the tabulated data positionally associated with a row heading.

12. The method of claim 1, wherein the first data category is associated with a keyword, and wherein the plurality of potential configurations comprises a data item positionally associated to the keyword.

13. The method of claim 1, wherein the first potential configuration defines one or more of:
a spatial position within the digital document;
a region within the digital document;
a positional association with an associated data item;
a key of a key-value pair;
a table column heading;
a table row heading;
a positional association with a structural element of the digital document;
a structural association with an associated data item;
a formatting style;
a pattern of a data item; and
a regular expression.

14. The method of claim 1, wherein the plurality of potential configurations comprises an ordered list of potential configurations.

15. The method of claim 14, further comprising determining the ordered list of potential configurations based on data extracted from a plurality of input documents.

16. The method of claim 14, further comprising adjusting an order of the ordered list of potential configurations based on data extracted from a plurality of input documents.

17. The method of claim 1, further comprising:
selecting a second data category of the plurality of data categories;
determining a plurality of potential configurations associated with the second data category of the plurality of data categories, the plurality of potential configurations comprising at least a first potential configuration for the second data category and a second potential configuration for the second data category; and
determining whether a data item associated with the second data category is positioned at the first potential configuration for the second data category.

18. The method of claim 1, wherein the digital document comprises a financial record.

19. A machine-readable storage medium storing instructions which, when executed by one or more processors, individually or in combination, cause the one or more processors to perform operations including:
receiving extracted information comprising information extracted from a digital document, the digital document encoding a plurality of data items, each data item of the plurality of data items being associated with a data category of a plurality of data categories, and each data item of the plurality of data items being associated with a configuration in the digital document;
selecting a first data category of the plurality of data categories;
determining a plurality of potential configurations associated with the first data category of the plurality of data categories, the plurality of potential configurations comprising at least a first potential configuration and a second potential configuration;
determining based on the extracted information, whether a data item associated with the first data category is identifiable at the first potential configuration; and
in response to a data item associated with the first data category not being positioned at the first potential configuration, determining, based on the extracted information, whether a data item associated with the first data category is identifiable at the second potential configuration.

20. A system comprising:
one or more processors; and
memory comprising computer executable instructions, which when executed by the one or more processors, individually or in combination, cause the system to perform operations including:
receiving extracted information comprising information extracted from a digital document, the digital document encoding a plurality of data items, each data item of the plurality of data items being associated with a data category of a plurality of data categories, and each data item of the plurality of data items being associated with a configuration in the digital document;
selecting a first data category of the plurality of data categories;
determining a plurality of potential configurations associated with the first data category of the plurality of data categories, the plurality of potential configurations comprising at least a first potential configuration and a second potential configuration;
determining based on the extracted information, whether a data item associated with the first data category is identifiable at the first potential configuration; and
in response to a data item associated with the first data category not being positioned at the first potential configuration, determining, based on the extracted information, whether a data item associated with the first data category is identifiable at the second potential configuration.
